(19) United States
(12) Patent Application Publication
(10) Pub. No.: US 2010/0137129 A1
(43) Pub. Date: Jun. 3, 2010

(54) PREPARATION OF SOLUTIONS OF RARE-EARTH ORGANOPHOSPHATES

(76) Inventor: Thomas Mathivet, Marans (FR)

Correspondence Address: BUCHANAN, INGERSOLL & ROONEY PC, POST OFFICE BOX 1404, ALEXANDRIA, VA, 22313-1404, US

(21) Appl. No.: 12/523,377

(22) PCT Filed: Jan. 22, 2008
(86) PCT No.: PCT/EP2008/050685

§ 371 Date: Jan. 29, 2010

(30) Foreign Application Priority Data
Jan. 23, 2007 (FR) 07/00444

(51) Int. Cl. B01J 31/18; B01J 23/10

(52) U.S. Cl. 502/162

(57) ABSTRACT

A method for preparing solutions of rare-earth organophosphates in an organic solvent includes a first step of reacting, with an organophosphated acid, a rare-earth compound selected from among the rare-earth oxides, hydroxides, acetates, carboxylates, carbonates and bicarbonates in the absence of the organic solvent of in the presence of the solvent in an amount not exceeding 50% of the final amount if the solvent in the solution; and a second step that includes adding the remaining quantity of the solvent to the product of the reaction of the preceding step.

The present invention relates to a process for preparing a solution of a rare-earth metal organophosphate in an organic solvent.

Solutions of rare-earth metal organophosphates are used in particular as starting material for preparing catalysts for the polymerization of dienes. Processes for preparing these solutions starting from aqueous solutions of rare-earth metal compounds, and involving a liquid/liquid extraction with an organic solvent, are known.

The aim of the invention is to provide an alternative to this type of process, i.e. a process not involving a liquid/liquid extraction, but nonetheless allowing an organic solution of satisfactory quality to be obtained.

With this aim, the process of the invention for preparing a solution of a rare-earth metal organophosphate in an organic solvent is characterized in that it comprises the following steps:
reacting, with an organophosphorus-based acid, a rare-earth metal compound chosen from rare-earth metal oxides, hydroxides, acetates, carboxylates, carbonates and bicarbonates, in the absence of said organic solvent or in the presence of solvent in an amount not exceeding 50% of the final amount of said solvent in the solution;
adding the remaining amount of solvent to the product of the reaction of the preceding step.

The process of the invention is easy to implement but results, however, in a solution of correct purity. This means that this solution has a content of starting rare-earth metal compound and a residual acidity that are low and in any case sufficient for subsequent use of the solution for preparing catalysts. This process also enables a good yield close or equal to 100% to be obtained.

Other characteristics, details and advantages of the invention will emerge on more clearly on reading both the following description and the various practical examples intended to illustrate the invention without limiting it.

“Rare-earth metal” is intended to mean, in the rest of the description, elements from the group constituted by yttrium and the elements from the periodic table of atomic numbers between 57 and 71 inclusive.

The process of the invention applies most particularly to the preparation of an organophosphate of a rare-earth metal chosen from neodymium, lanthanum, praseodymium and cerium.

The first step of the process of the invention consists in reacting a rare-earth metal compound of the above-described type with an organophosphorus-based acid.

The abovementioned compounds can be used as rare-earth metal compounds. In the case of carboxylates, these are more particularly chosen from compounds containing 1 to 5 carbon atoms. Mention may be made especially of acetates, propionates and formates.

Among all the rare-earth metal compounds mentioned, oxides and hydroxides may be used more particularly.

The organophosphorus-based acid may be more particularly chosen from monoesters and diesters of phosphoric acid of respective formulae (RO)PO(OH)₂ and (RO)(R′O)PO(OH), in which R and R′, which may be identical or different, represent alkyl or aryl radicals.

By way of example, R and R′ may be n-butyl, isobutyl, pentyl, amyl, isopentyl, 2,2-dimethylhexyl, 2-ethylhexyl, 1-ethylhexyl, octyl, nonyl, decyl, 2,2-dimethyloctyl, tolyl or nonaphenyl radicals.

The organophosphorus-based acid may also be chosen from phosphonic acids of general formulae (RO)R′P(O) (OH) and RP(O)(OH)₂, in which R and R′, which may be identical or different, represent alkyl or aryl radicals. By way of example, R and R′ may be n-butyl, isobutyl, pentyl, amyl, isopentyl, 2,2-dimethylhexyl, 2-ethylhexyl, 1-ethylhexyl, octyl, nonyl, decyl, 2,2-dimethyloctyl, tolyl or nonaphenyl radicals.

The organophosphorus-based acid may also be chosen from phosphinic acids of general formulae R(R′)P(O)OH and R(H)P(O)OH, in which R and R′, which may be identical or different, represent alkyl or aryl radicals. By way of example, R and R′ may be n-butyl, isobutyl, pentyl, amyl, isopentyl, 2,2-dimethylhexyl, 2-ethylhexyl, 1-ethylhexyl, octyl, nonyl, decyl, 2,2-dimethyloctyl, tolyl or nonaphenyl radicals.

Mixtures of the organophosphorus-based acids described above may, of course, be used.

The reaction of the rare-earth metal compound with the organophosphorus-based acid is generally performed at a temperature of at least 60° C. and more particularly between 80° C. and 100° C. However, temperatures above 100° C. are conceivable.

The duration of this attack can vary within wide limits, for example between 2 and 6 hours.

According to one important characteristic of the invention, the first step of the process is performed in the presence of an amount of organic solvent not exceeding 50% of the final amount of solvent that will be present in the solution that it is sought to obtain. More particularly, this amount of solvent present in the first step does not exceed 30%, especially does not exceed 20%, and even more particularly does not exceed 10% of the total amount.

According to one preferred embodiment of the invention, the amount of solvent present in the first step is zero, this first step then being performed in the absence of solvent.

The second step of the process therefore consists in adding the remaining amount of solvent to the product obtained from the preceding step. In the case of the embodiment where the first step is performed in the total absence of solvent, the latter is introduced in full in the second step.

The organic solvent used is generally a hydrocarbon-based solvent, more particularly an aliphatic, cycloaliphatic or even aromatic solvent.

This solvent may be chosen from the group comprising hexane, cyclohexane, methylcyclohexane, heptane, methylpentane, methylcyclopentane, pentane, 3-methylpentane, 2-methylpentane, 2,3-dimethylpentane, and the isomers thereof, toluene and xylenes, and mixtures thereof. Hexane, cyclohexane, methylcyclohexane, isomers and mixtures thereof are preferred. The hydrocarbon-based solvents available commercially are the Exxsol® hexanes from Exxon, Exxsol® heptane from Exxon, Isopar®, Isopar-M® and Isopar-L® from Exxon, Solvent 140® from Exxon, Mineral Spirits 66® from Philips, cyclohexane from BASF and methylcyclohexane from Total Fluides.

After the addition of the solvent, a solution of rare-earth metal organophosphate is obtained. This solution may optionally be subjected to a distillation step to eliminate the residual water. It is thereby possible to obtain a solution with a water content not exceeding 500 ppm and more particularly not exceeding 100 ppm. This water content, expressed as the water/rare-earth metal mole ratio, may be at most 0.2 and more particularly at most 0.04.

The residual acidity, expressed by the organophosphorus-based acid/rare-earth metal mole ratio, does not exceed 0.5, more particularly does not exceed 0.3.

The yield of the reaction is high, as only a very small amount of starting rare-earth metal compound is left in the solution. Indeed, the solution has a clear aspect.

It is possible to adjust the viscosity of the solution obtained by adding thereto a compound chosen from alcohols, carboxylic acids and phosphoric acids. Non-limiting examples that may be mentioned include ethanol, ethylene glycol, propylene glycol, dipropylene glycol, acetic acid and propionic acid.

As mentioned above, the rare-earth metal organophosphate solutions resulting from the process of the invention may be used for preparing catalysts for the polymerization of dienes such as butadiene and isoprene.

Examples will now be given.

### COMPARATIVE EXAMPLE 1

3.03 g of neodymium oxide, 16.25 g of bis(2-ethylhexyl)phosphoric acid (DEHPA) and 80 g of methylcyclohexane (MCH) are introduced into a reactor previously made inert with argon. The mixture is then maintained at 90° C. for 2 hours. The water/MCH azeotrope is then distilled off using Dean-Stark apparatus. A solution of neodymium bis(2-ethylhexyl)phosphate in MCH is thus obtained. It is characterized by a very cloudy aspect due to the abundant presence of residual Nd₂O₃, a content of dissolved neodymium of 1.6%, a residual free acidity expressed as a weight percentage of DEHPA of 2.5% and a water content of 400 ppm. In this case, the mole ratios are as follows: DEHPA/Nd=0.70 and water/Nd=0.20. The yield of attack is 70%.

### EXAMPLE 2

3.03 g of neodymium oxide, 17.8 g of DEHPA and 8.08 g of MCH are introduced into a reactor previously made inert with argon. The mixture is then maintained at 90° C. for 2 hours. 77.27 g of MCH are then added and the water from the reaction is eliminated by distillation of the water/MCH azeotrope using Dean-Stark apparatus. A clear solution of neodymium bis(2-ethylhexyl)-phosphate in MCH is thus obtained. It is characterized by a clear aspect, a neodymium content of 2.2%, a residual free acidity expressed as a weight percentage of DEHPA of 1.7% and a water content of 90 ppm. In this case, the mole ratios are as follows: DEHPA/Nd=0.35 and water/Nd=0.03. The yield of attack is 100%.

### EXAMPLE 3

4.09 g of neodymium hydroxide containing 63.46% by weight of Nd, 17.8 g of DEHPA and 6.41 g of MCH are introduced into a reactor previously made inert with argon. The mixture is maintained at 90° C. for 1 hour, and then at 120° C. for 3 hours. 74.55 g of MCH are then added and the heating is continued at 140° C. for 3 hours. The water/MCH azeotrope is then distilled off using Dean-Stark apparatus. A solution of neodymium bis(2-ethylhexyl)phosphate in MCH is thus obtained. It is characterized by a clear aspect, a neodymium content of 2.4%, a residual free acidity expressed as a weight percentage of DEHPA of 1.9% and a water content of 304 ppm. In this case, the mole ratios are as follows: DEHPA/Nd=0.35 and water/Nd=0.10. The yield of attack is 96%.

### EXAMPLE 4

5.79 g of neodymium acetate and 17.39 g of DEHPA are introduced into a reactor previously made inert with argon. The mixture is maintained at 90° C. for 1 hour, 7.31 g of MCH are then added and this mixture is maintained at 120° C. for 1 hour. 140.9 g of MCH are added to the mixture, and the water/MCH azeotrope is then subjected to a flash distillation. 28.05 g of a water/MCH/acetic acid mixture are thus eliminated from the product. A solution of neodymium bis(2-ethylhexyl)phosphate in MCH is thus obtained. It is characterized by a clear aspect, a neodymium content of 1.7%, a residual free acidity expressed as a weight percentage of DEHPA of 1.1% and a water content of 96 ppm. In this case, the mole ratios are as follows: DEHPA/Nd=0.29 and water/Nd=0.04. The yield of attack is 100%.

1-6. (canceled)

7. A process for preparing a solution of a rare-earth metal organophosphate in an organic solvent, which comprises the following steps:
reacting, with an organophosphorus-based acid, a rare-earth metal compound selected from the group consisting of rare-earth metal oxides, hydroxides, acetates, carboxylates, carbonates and bicarbonates, in the absence of said organic solvent or in the presence of solvent in an amount not exceeding 50% of the final amount of said solvent in the solution; and
adding the remaining amount of solvent to the product of the reaction of the preceding step.

8. The process as defined by claim 7, wherein said organophosphorus-based acid is selected from the group consisting of the monoesters and diesters of phosphoric acid, phosphonic acids and phosphinic acids.

9. The process as defined by claim 7, said organic solvent comprising a hydrocarbon-based solvent.

10. The process as defined by claim 7, for preparing a solution of an organophosphate of a rare-earth metal selected from the group consisting of neodymium, lanthanum, praseodymium and cerium.

11. The process as defined by claim 7, wherein the reaction of the rare-earth metal compound with the organophosphate is carried out at a temperature of at least 60° C.

12. The process as defined by claim 7, wherein all of the solvent is added in the second step.

13. The process as defined by claim 7, said organic solvent comprising an aliphatic or cycloaliphatic solvent.
